(19) United States
(12) Patent Application Publication
(10) Pub. No.: US 2023/0073659 A1
(43) Pub. Date: Mar. 9, 2023

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Keiichi Yamamoto, Kanagawa (JP)

(21) Appl. No.: 17/822,935

(22) Filed: Aug. 29, 2022

(30) Foreign Application Priority Data
Sep. 7, 2021 (JP) 2021-145182

(51) Int. Cl. G06V 10/25; G06V 10/74; G06V 40/10; G06V 40/16; G06T 7/13; G06T 7/40; G06T 7/62; G06T 7/70

(52) U.S. Cl. CPC G06V 10/25; G06V 10/761; G06V 40/103; G06V 40/161; G06T 7/13; G06T 7/40; G06T 7/62; G06T 7/70; G06T 2207/10144; G06T 2207/30168

(57) ABSTRACT

An apparatus includes a detection unit detecting a first region on an acquired image, an adjustment unit performing first image quality adjustment on the acquired image, wherein the detection unit further detects the first region or a second region on the adjusted image, a storage unit storing information about the first region as exclusion information in a case where neither the first region nor the second region are detected, wherein, in a case where the second region is detected by the detection unit, the adjustment unit further performs the first image quality adjustment or second image quality adjustment on the adjusted image, and a comparison unit comparing information about a region detected before the first image quality adjustment and the exclusion information, wherein the adjustment unit determines whether to perform the first image quality adjustment based on a comparison result obtained by the comparison unit.

### BACKGROUND

### Technical Field

The aspect of the embodiments relates to an information processing apparatus, a control method, and a storage medium.

### Description of the Related Art

Japanese Patent Application Laid-Open No. 2015-130615 discusses a technique that enables an apparatus to capture an image with an exposure appropriate for a person with the amount of exposure adjusted based on a detection result of the face region or the human body region.

### SUMMARY

According to an aspect of the disclosure, an apparatus includes an acquisition unit configured to acquire an image, a detection unit configured to detect a first region including a human body on the acquired image, an adjustment unit configured to perform first image quality adjustment on the acquired image based on an image of the detected first region, wherein the detection unit further detects the first region or a second region including a face on the adjusted image, a storage unit configured to store information about the first region as exclusion information in a case where neither the first region nor the second region are detected, wherein, in a case where the second region is detected, the adjustment unit performs the first image quality adjustment or second image quality adjustment on the adjusted image based on an image of the second region, a comparison unit configured to compare information about a region detected before the first image quality adjustment and the exclusion information, wherein the adjustment unit determines whether to perform the first image quality adjustment based on a comparison result obtained by the comparison unit.

Further features of the disclosure will become apparent from the following description of exemplary embodiments with reference to the attached drawings.

### BRIEF DESCRIPTION OF THE DRAWINGS

FIG. 1 is a diagram illustrating an example of the system configuration of an information processing system.

FIG. 2 is a block diagram illustrating an example of the functional configuration of an information processing apparatus.

FIGS. 3A to 3C are diagrams illustrating an example of image quality adjustment made by the information processing apparatus.

FIG. 4 is a flowchart illustrating an example of processing performed by the information processing apparatus.

FIGS. 5A to 5D are diagrams illustrating another example of image quality adjustment made by the information processing apparatus.

FIG. 6 is a flowchart illustrating another example of processing performed by the information processing apparatus.

FIGS. 7A to 7E are diagrams illustrating another example of image quality adjustment made by the information processing apparatus.

FIG. 8 is a flowchart illustrating another example of processing performed by the information processing apparatus.

FIG. 9 is a flowchart illustrating another example of processing performed by the information processing apparatus.

FIG. 10 is a diagram illustrating an example of a hardware configuration of the information processing apparatus.

### DESCRIPTION OF THE EMBODIMENTS

Hereinafter, some exemplary embodiments that implement the disclosure will be described in detail with reference to the appended drawings. The exemplary embodiments described hereinafter are examples that realize the disclosure, and should be modified or changed as appropriate depending on a configuration or various conditions of an apparatus to which the disclosure is applied. The disclosure therefore is not limited to the below-described exemplary embodiments. Further, the below-described exemplary embodiments may be partially combined as appropriate.

### <System Configuration>

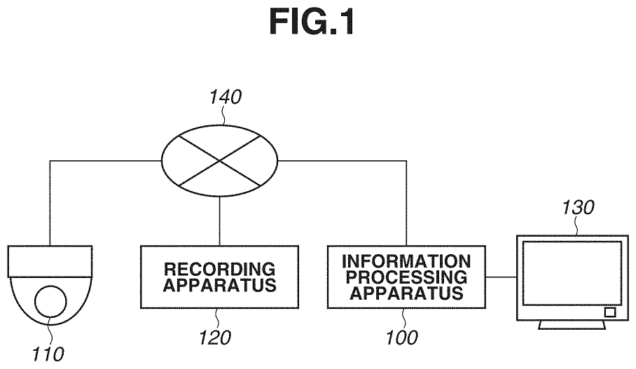

FIG. 1 is a diagram illustrating the system configuration according to a first exemplary embodiment. The system according to the present exemplary embodiment includes an information processing apparatus 100, an image capturing apparatus 110, and a recording apparatus 120.

The information processing apparatus 100, the image capturing apparatus 110, and the recording apparatus 120 are mutually connected to one another via a network 140. The network 140 includes a plurality of routers, switches, and cables compliant with communication standards such as Ethernet®. The network 140 may also be the internet, a wired local area network (LAN), a wireless LAN, and/or a wide area network (WAN).

The information processing apparatus 100 is a personal computer with programs for performing the below-described information processing functions according to the present exemplary embodiment installed in it.

The image capturing apparatus 110 is an apparatus that captures images. The image capturing apparatus 110 associates image data about a captured image, the information about the time at which the image is captured, and the identification information for identifying the image capturing apparatus 110 with one another to transmit them to external apparatuses such as the information processing apparatus 100 and the recording apparatus 120 via the network 140. In addition, although the system according to the present exemplary embodiment includes a single image capturing apparatus 110, the system may include more than one image capturing apparatus 110.

The recording apparatus 120 records image data about a captured image, the information about the image capturing time, and the identification information in association with one another. Further, according to a request from the information processing apparatus 100, the recording apparatus 120 transmits recorded data (e.g., an image, the image capturing time, and the identification information) to the information processing apparatus 100.

A display 130 includes a liquid crystal display (LCD), and displays information processing results acquired by the information processing apparatus 100 and images captured by the image capturing apparatus 110. The display 130 is connected to the information processing apparatus 100 via a display cable compliant with a communication standard such as High Definition Multimedia Interface (HDMI)®. Further, the display 130 functions as a display unit to display images captured by the image capturing apparatus 110 and results acquired through the information processing described below.

In addition, the display 130, the information processing apparatus 100, and the recording apparatus 120 all, or at least two of them, may be installed in a single housing. Further, the information processing apparatus 100 and the image capturing apparatus 110 may be installed in a single housing. In other words, the image capturing apparatus 110 may have the below-described functions and configurations of the information processing apparatus 100.

Further, an information processing result acquired by the information processing apparatus 100 and an image captured by the image capturing apparatus 110 may be displayed on a display included in the following external apparatus instead of being displayed on the display 130 connected to the information processing apparatus 100 via the display cable. In other words, for example, an information processing result and a captured image may be displayed on a display included in a mobile device such as a smartphone or a tablet terminal connected thereto via the network 140. Furthermore, an information processing result acquired by the information processing apparatus 100 may be transmitted to an image analysis apparatus installed in a housing in which the information processing apparatus 100 is installed or another housing connected thereto via the network 140. For example, the image analysis apparatus refers to an apparatus that performs face recognition processing to detect a person identical to a pre-registered person from a captured image.

### <Functional Configuration>

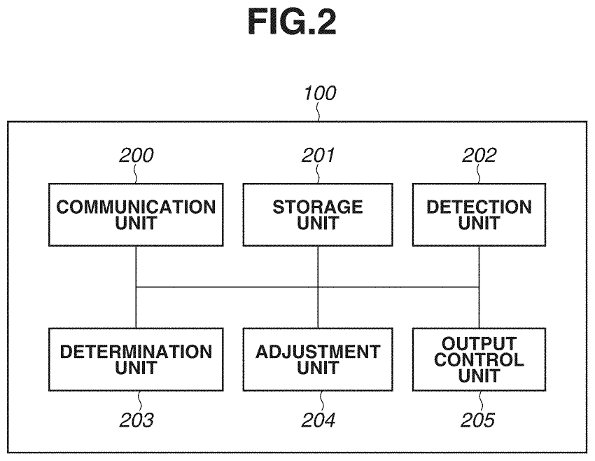

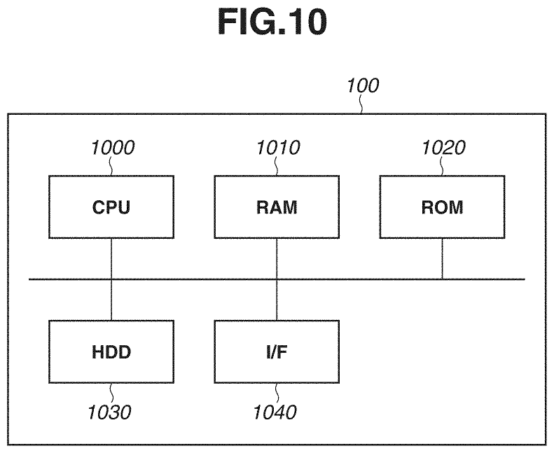

FIG. 2 is a block diagram illustrating a functional configuration of the information processing apparatus 100 according to the present exemplary embodiment. From among the functional blocks illustrated in FIG. 2, a functional block of software is implemented by a central processing unit (CPU) 1000 and a read only memory (ROM) 1020 described below with reference to FIG. 10. In other words, each of the functions illustrated in FIG. 2 is implemented by the CPU 1000 of the information processing apparatus 100 running computer programs stored in the ROM 1020 of the information processing apparatus 100.

Further, each of the functions illustrated in FIG. 2 may be implemented by a configuration that also includes a random access memory (RAM) 1010 and a hard disk drive (HDD) 1030 described below with reference to FIG. 10, in addition to the CPU 1000 and the ROM 1020. For example, computer programs stored in the ROM 1020 may be moved in the RAM 1010 capable of operating at a higher speed, so that the CPU 1000 reads the computer program from the RAM 1010. Alternatively, computer programs to run, which are stored in the HDD 1030 with a larger capacity, may be moved in the RAM 1010.

A communication unit 200 includes an interface (I/F) 1040 described below with reference to FIG. 10. The communication unit 200 communicates with the image capturing apparatus 110 and the recording apparatus 120 via the network 140. For example, the communication unit 200 receives image data about a captured image from the image capturing apparatus 110, and transmits control commands for controlling the image capturing apparatus 110 to the image capturing apparatus 110. Thus, the communication unit 200 functions as an image acquisition unit to acquire images. In addition, the control commands include commands for instructing the image capturing apparatus 110 to capture images and commands for setting an exposure correction value through adjustment of exposure, focus, and white balance of the image capturing apparatus 110.

A storage unit 201 includes the RAM 1010 and the HDD 1030 described below with reference to FIG. 10. The storage unit 201 stores information and data relating to information processing performed by the information processing apparatus 100. For example, patterns of pattern matching (i.e., patterns each corresponding to a feature portion of a human body), used when a detection unit 202 described below performs human body detection, are previously stored in the HDD 1030. In order to achieve high-speed processing, the patterns may be partially loaded into the RAM 1010 from the HDD 1030.

The detection unit 202 detects the region corresponding to a person captured as an object in an image. Specifically, for example, the detection unit 202 detects the human body region (first region) corresponding to the body of a person and the face region (second region) corresponding to the face of the person from a target image such as an image acquired from the image capturing apparatus 110 or the recording apparatus 120. Thus, the detection unit 202 functions as a human body detection unit (first detection unit) and also functions as a face detection unit (second detection unit). Face detection may be performed as the second human body detection described below. Further, a known method, whose details will be omitted, can be employed for detecting a human body region from an image. In other words, a human body detection method is not limited to a specific detection method, and various methods such as a detection method based on machine learning and a detection method based on distance information can be employed. In the present exemplary embodiment, the first human body detection is firstly performed. Then, if a human body region is detected, information about the human body region is temporarily stored in the storage unit 201.

A determination unit (comparison unit) 203 determines whether information about a human body region similar to a human body region detected by the detection unit 202 through human body detection exists in the below-described exclusion information. More specifically, the determination unit (comparison unit) 203 compares information about a detected human body region or a detected face region with exclusion information and makes a determination based on the comparison result.

If a human body region is detected by the detection unit 202, and the determination unit 203 determines that information about a similar human body region does not exist in the exclusion information, an adjustment unit 204 performs image quality adjustment (first image quality adjustment) suitable to the image quality of the detected human body region. For example, if the human body region is dark because of backlight, the adjustment unit 204 performs exposure adjustment or exposure correction to adjust image quality relating to the exposure of the image to brighten the human body region.

Next, while the first image quality adjustment is being performed or after the first image quality adjustment is made, or both of the timings, the detection unit 202 performs the second human body detection one or more times. For example, human body detection is performed under the condition that a human body region is brightened through the adjustment made by the adjustment unit 204 with higher accuracy than under the condition that a human body region is dark before the adjustment, through which the detected human body region is highly likely to include a person. If a human body region is detected by the second human body detection, the adjustment unit 204 therefore performs the second image quality adjustment based on the image quality of the detected human body region because of a high probability that a person is detected accurately. In this manner, image quality adjustment is made based on the image quality of the human body region detected with accuracy, so that image quality adjustment more suitable to a person is performed. Further, if a human body region is detected by the second human body detection, the first image quality adjustment may be maintained because of a high probability that the human body region detected by the first human body detection also includes a person. In addition, the image quality relating to exposure of the image may be adjusted by both the first image quality adjustment and the second image quality adjustment, or white balance correction and adjustment of another element such as focus adjustment may be performed thereby.

If a human body region is not detected by the second human body detection, the human body region detected by the first human body detection is lower likely to include a person, and the human body region information temporarily stored in the storage unit 201 is registered in the exclusion information. The human body region information can be newly added to a stored region held in the exclusion information, or an exclusion information flag can be set to the human body region information temporarily stored therein for registration. Further, the image quality thereof may be brought back to a state before the first image quality adjustment as the first image quality adjustment is highly likely to be performed on an object other than a person. In the present exemplary embodiment, the exclusion information is stored in the storage unit 201. However, an exclusion information acquisition unit (not illustrated) may acquire the exclusion information from an external storage device. The exclusion information acquisition unit acquires exclusion information, i.e., information about an optional region in an image. An optional region according to the present exemplary embodiment refers to a region that is detected by the first human body detection but is not detected by the second human body detection. Further, the user may specify a human body region or a face region detected by the first or the second human body detection as exclusion information via the external apparatus described below to cause the storage unit 201 to store the exclusion information or to cause the exclusion information acquisition unit to acquire the exclusion information.

An output control unit 207 outputs an image adjusted by the adjustment unit 204 to external apparatuses such as the recording apparatus 120 and the display 130. For example, if an external apparatus is the display 130, an image adjusted by the adjustment unit 204 is displayed on the display 130. In addition, an image may be output to another program installed in the information processing apparatus 100 or an external apparatus operating as another information processing apparatus, so that the image is used in image analysis such as face recognition.

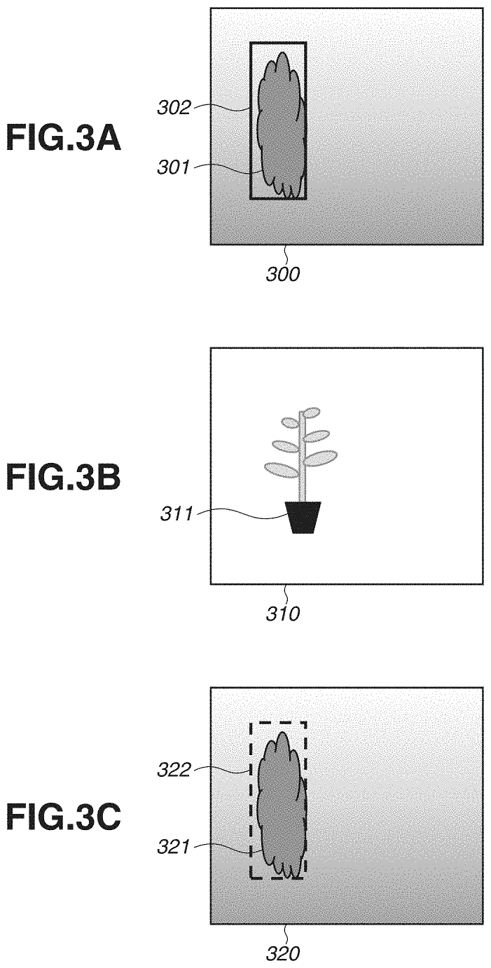

Subsequently, information processing performed by the information processing apparatus 100 according to the present exemplary embodiment will be described with reference to FIGS. 3A to 3C.

FIG. 3A illustrates an image 300 acquired by the image capturing apparatus 110 or the recording apparatus 120 via the communication unit 200 at a point of time. An object 301 is captured in the image 300, and a human body region 302 is detected by the detection unit 202 through the first human body detection. Information about the detected human body region 302 is temporarily stored in the storage unit 201. Herein, the determination unit 203 determines that information about a human body region similar to the human body region 302 does not exist in the below-described exclusion information. As a result, the adjustment unit 204 performs the first image quality adjustment based on the image quality of the human body region 302. Herein, for example, the adjustment unit 204 performs exposure correction to adjust the average of luminance values of pixels in the human body region 302 to be a suitable luminance value. In the example illustrated in FIGS. 3A to 3C, the adjustment unit 204 performs exposure correction to increase (brighten) the luminance due to low luminance in the human body region 302. Further, in order to perform image quality adjustment more suitable to a face portion in a human body region, the adjustment unit 204 may estimate the position of a face region from the human body region to calculate the average luminance value of the estimated face region.

For example, the horizontal position of the estimated face region is estimated as 80% of the central portion of the horizontal position of the human body region, and the vertical position of the estimated face region is estimated as 90% to 60% of the upper portion of the vertical position of the human body region.

In addition to correction of exposure, elements relating to the exposure, such as a shutter speed, an aperture, and a gain may directly be adjusted by the image quality adjustment. Further, a focus or a white balance may also be adjusted by the image quality adjustment. Adjustment may be performed based on the image quality of the human body region.

FIG. 3B illustrates an image acquired as a result of the first image quality adjustment. The adjustment unit 204 performs exposure correction on the object 301 in FIG. 3A, so that the object 301 is brightened and captured as an object 311 in an image 310.

Herein, although the detection unit 202 performs the second human body detection, a human body region is not detected as the object 311 is not a person. Thus, the human body region 302 detected on the image 300 in FIG. 3A is determined as an object other than a person, so that the information about the human body region 302 temporarily stored in the storage unit 201 is registered in the exclusion information. As the first image quality adjustment has been performed on an object other than a person, the image quality is brought back to a state before the first image quality adjustment.

FIG. 3C illustrates an image brought back to the dark state before the image quality adjustment. Similar to the image 300 in FIG. 3A, an object 321 exists in an image 320, and is detected as a human body region 322 through the first human body detection. An object can be erroneously detected as a person in a dark or unclear image. Thus, as illustrated in FIG. 3C, in the dark image, the same object can be detected as a person again. Herein, the determination unit 203 determines whether information about a human body region similar to the human body region 322 exists in the exclusion information. As a specific method for determining whether similar human body region information exists, for example, there is a method for comparing positions indicated by all of the human body region information registered in the exclusion information with the position of the human body region 322. If human body region information indicating a value of position less than a threshold value is registered in the exclusion information, the determination unit 203 determines that information about a similar human body region exists in the exclusion information. In the example illustrated in FIGS. 3A to 3C, the position of the human body region 322 in the x-y coordinates in the image is close to that of the human body region 302 whose information is registered in the exclusion information. Thus, the determination unit 203 determines that information about a similar human body region exists in the exclusion information. Any position in the x-y coordinates in the human body region can be used for comparison. For example, the coordinates of the gravity center point of a human body region, the position of one of the points at four corners of the human body region, the positions of all of the points at four corners thereof, or the average of the positions of all of the points at four corners thereof may be used for comparison.

Then, the adjustment unit 204 does not perform image quality adjustment (the second image quality adjustment) on the human body region 322 as the determination unit 203 determines that information about a human body region similar to the human body region 322 exists in the exclusion information.

Further, the similarity of human body region information may be determined based on the condition that the sizes of human body regions are close to each other. Further, the similarity of human body region information may be determined based on the condition that the image information about the human body regions such as outline (edge) information or surface texture information about an object is close to each other, or the similarity thereof may be determined based on a combination of the above-described conditions. Further, in determination based on the closeness of position, the similarity cannot be determined if an object is significantly moved. In this case, the movement of the human body region may be detected through a known technique such as moving object detection or moving object tracking, and the similarity is determined based on a condition other than the closeness of the positions.

As described above, information about a human body region determined as an object other than a person is registered in the exclusion information. Then, even if a human body region similar to a human body region whose information is registered in the exclusion information is detected through the subsequent human body detection, the detected human body region is ignored. In this matter, useless image quality adjustment is not performed on the object other than a person. As a result, suitable image quality adjustment is performed on a person alone.

### <Description of Operation>

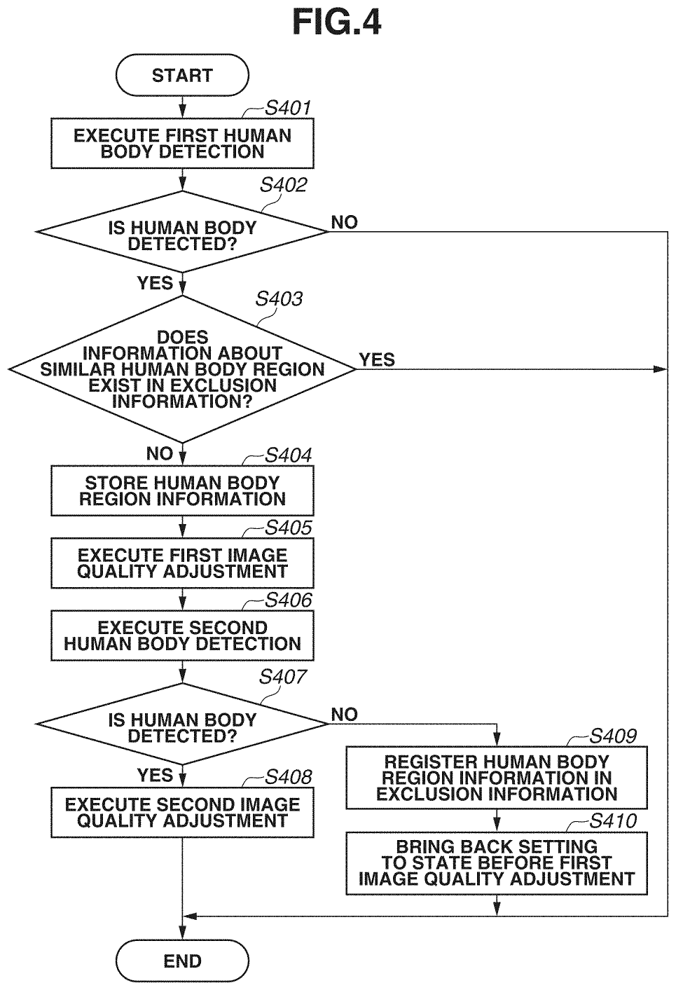

Next, image quality adjustment processing performed by the information processing apparatus 100 according to the present exemplary embodiment will be described with reference to the flowchart in FIG. 4. Processing illustrated in this flowchart is performed repeatedly. Further, this flowchart illustrates processing performed by the functional blocks of the information processing apparatus 100 illustrated in FIG. 2.

First, in step S401, the detection unit 202 performs the first human body detection on an image captured by the image capturing apparatus 110 and acquired by the communication unit 200. As described above, a human body detection method is not limited to a specific detection method, and various detection methods such as a detection method based on pattern matching, machine learning, or distance information can be employed.

Next, in step S402, if a human body is detected in step S401 (YES in step S402), the processing proceeds to step S403. Otherwise (NO in step S402), the processing of this flowchart is ended.

In step S403, the determination unit 203 determines whether information about a human body region similar to the human body region detected in step S401 exists in the exclusion information. If information about a similar human body region exists in the exclusion information (YES in step S403), the processing of this flowchart is ended without performing image quality adjustment as information about the detected human body region is already registered in the exclusion information as the information about a human body region including an object other than a person. At this time, the human body region information determined as similar information, registered in the exclusion information, may be updated or replaced with the latest information, i.e., information about the human body region detected in step S401. If the similar human body region information does not exist in the exclusion information (NO in step S403), the detected human body region may include a person. Thus, the processing proceeds to step S404, and subsequent image quality adjustment processing is performed.

Next, in step S404, the information about the human body region detected in step S401 is temporarily stored in the storage unit 201.

In step S405, the adjustment unit 204 performs the first image quality adjustment based on the image quality of the human body region detected in step S401. As described above, the adjustment unit 204 may perform image quality adjustment based on the image quality of the entire human body region, or on the image quality of an estimated face region by estimating the position of the face region from the human body region. Further, the adjustment unit 204 may perform exposure correction or adjustment on various elements such as an ISO sensitivity, a shutter speed, an aperture, a gain, a focus, and a white balance through the image quality adjustment.

Image quality adjustment of any element can be performed as long as suitable adjustment is performed based on the image quality of the human body region.

Next, in step S406, while the first image quality adjustment is being performed or after the first image quality adjustment is performed, or at both of these timings, the detection unit 202 performs the second human body detection one or more times. The human body detection is performed through a method similar to the method used for the first human body detection in step S401.

In step S407, if a human body region is detected in step S406 (YES in step S407), the processing proceeds to step S408. Otherwise (NO in step S407), the processing proceeds to step S409.

In step S408, the adjustment unit 204 performs the second image quality adjustment based on the image quality of the human body region detected in step S406. The image quality adjustment is performed through a method similar to the method used for the first image quality adjustment in step S405. The second image quality adjustment uses the result of the second human body detection acquired under a condition more favorable than a condition of the first human body detection, allowing image quality adjustment more suitable to a person to be performed. However, image quality adjustment has already been performed with respect to the result of the first human body detection through the first image quality adjustment. Thus, for the purpose of shortening the processing time, the result of the first image quality adjustment may be maintained without performing the second image quality adjustment.

in response to no detection of a human body region through the second human body detection, in step S409, the human body region information temporarily stored in the storage unit 201 in step S404 is determined as information about an object other than a person, so that the human body region information is registered in the exclusion information. As the human body region information is registered in the exclusion information in step S409, even if the same object is detected as a human body region in step S401 in the next processing of this flowchart, the detected human body region is ignored as a human body region whose information is similar to the human body region information registered in the exclusion information in step S403.

In step S410, the adjustment unit 204 determines that the first image quality adjustment is performed based on the image quality of an object other than a person, and brings the image quality setting to a state before the first image quality adjustment as a human body region is not detected through the second human body detection. However, the image quality setting does not always have to be brought back to a previous state.

As described above, according to the present exemplary embodiment, even if an object other than a person is erroneously detected through the first human body detection with an unsuitable image quality, the second human body detection is performed with an image quality improved by the first image quality adjustment. If a human body region is not detected by the second human body detection, the human body region detected by the first human body detection is determined as an object other than a person, so that the information about the detected human body region is registered in the exclusion information. Then, if a human body region whose information is similar to the human body region information registered in the exclusion information is detected by the first human body detection, the detected human body region is ignored when subsequent image quality adjustment processing is performed.

Thus, according to the present exemplary embodiment, for example, even if a human body region erroneously detected as a person exists in a portion darkened with backlight, image quality adjustment will not be performed thereon with information about a human body region similar to the detected human body region registered in the exclusion information, so that useless image quality adjustment is not performed. As a result, suitable image quality adjustment is performed on a person alone.

A second exemplary embodiment will be described. In the first exemplary embodiment, when a human body region similar to a human body region whose information is registered in the exclusion information is detected, the detected human body region is ignored, and image quality adjustment is not performed. However, even if a person is actually detected by the first human body detection, this person may not be detected by the second human body detection if the person faces the other way. In this case, the information about the human body region detected by the first human body detection is registered in the exclusion information, and the human body region is ignored even though that human body region is a person.

Thus, in the present exemplary embodiment, similarity between human body regions is determined based on a combination of information about the position of a human body region and image information such as outline information and texture information about an image within the human body region. Then, if a change in the image information occurs, image quality adjustment is performed again, and a determination is made on whether the human body region includes a person.

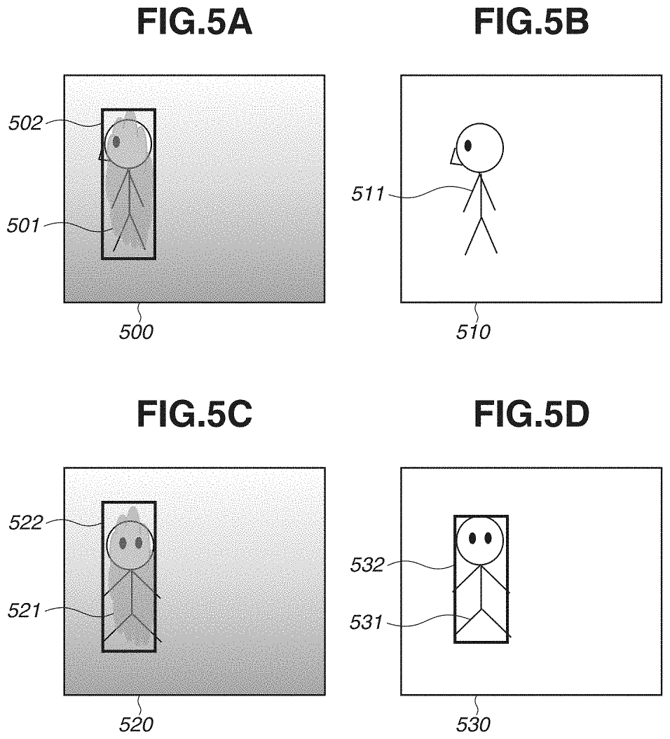

First, information processing performed by the information processing apparatus 100 according to the present exemplary embodiment will be described with reference to FIGS. 5A to 5D. The functional configuration of the information processing apparatus 100 according to the present exemplary embodiment is similar to that of the first exemplary embodiment, and the redundant descriptions thereof will be omitted.

FIG. 5A illustrates an image 500 acquired from the image capturing apparatus 110 or the recording apparatus 120 via the communication unit 200 at a point of time. A person 501 is captured in the image 500, and a human body region 502 is detected by the detection unit 202 through the first human body detection. Information about the detected human body region 502 is temporarily stored in the storage unit 201. Herein, the determination unit 203 determines that no information about a human body region similar to the human body region 502 exists in the exclusion information. Thus, the adjustment unit 204 performs the first image quality adjustment based on the image quality of the human body region 502. In the example illustrated in FIGS. 5A to 5D, the adjustment unit 204 performs exposure correction to increase (brighten) the low luminance within the human body region 502. A human body detection method, an image quality adjustment method, and processing for determining the similarity are similar to those described in the first exemplary embodiment, so that the descriptions thereof will be omitted.

FIG. 5B illustrates an image acquired as the result of the first image quality adjustment. The adjustment unit 204 performs exposure correction on the person 501 in FIG. 5A, so that the person 501 is brightened and captured as a person 511 in an image 510.

Herein, the detection unit 202 performs the second human body detection. However, the person 511 faces the other way, which prevents an omega (Ω)-shape of a head and a shoulder as a feature of a face and a human shape from being detected, which prevents the detection unit 202 from detecting the human body. Thus, the human body region 502 detected on the image 500 in FIG. 5A is determined to include an object other than a person, so that the information about the human body region 502 temporarily stored in the storage unit 201 is registered in the exclusion information. Then, the setting is brought back to a state before the first image quality adjustment.

FIG. 5C illustrates an image in the dark state before the image quality adjustment, which is brought back from the previous processing. Changing from the state illustrated in FIG. 5A, the person 501 in an image 520 is captured as a person 521 facing forward and detected as a human body region 522 through the first human body detection. At this point, the determination unit 203 determines whether information about a human body region similar to the human body region 522 exists in the exclusion information. The determination unit 203 firstly determines whether information about a human body region located close to the human body region 522 exists in the exclusion information. In the example illustrated in FIGS. 5A to 5D, the determination unit 203 determines that the human body region 522 is located close to the human body region 502 whose information is registered in the exclusion information.

If information about a human body region located close to the human body region 522 exists in the exclusion information, the determination unit 203 determines whether the pieces of image information (i.e., edge information and texture information) in the human body regions 522 and 502 are similar to each other. Herein, because the person facing the other way turned to face forward, the person's face in outline has been changed to a frontal face, so that the outline information and the texture information such as a pattern of the clothes have been changed. A known method can be used for extracting edge information or texture information, and the descriptions of the extraction method will be omitted. A method for determining the similarity of the edge information and the texture information, for example, includes extracting the edge information and the texture information from the images before and after a change, and determining the similarity when the total or average of differences between the extracted pixel values of pixels before and after the change is a predetermined threshold value or lower. The similarity may be determined when the edge information and/or the texture information satisfy the above condition, or the similarity may be determined using the edge information or the texture information. In other words, any method can be used as long as the change of the state in the human body region can be detected thereby. Thus, a method may use a known technique such as moving object detection or moving object tracking to determine that an object in a human body region has moved. In the example illustrated in FIGS. 5A to 5D, the person 501 facing the other way turned forward into a state of the person 521 who faces forward. Thus, the determination unit 203 determines that the difference between the image information about the human body region 502 registered in the exclusion information and the image information about the newly detected human body region 522 is a predetermined threshold value or greater, and determines that the persons in the human body regions 502 and 522 are not similar to each other.

If the determination unit 203 determines that no information about a human body region located close to the detected human body region or image information similar to image information about the detected human body region exists in the exclusion information, the adjustment unit 204 performs image quality adjustment based on the image quality of the human body region detected by the detection unit 202. In the example illustrated in FIGS. 5A to 5D, the determination unit 203 determines that no image information similar to that in the human body region 522 exists, although information about a human body region located close to the human body region 522 exists in the exclusion information. Thus, image quality adjustment is performed based on the image quality of the detected human body region 522. Herein, the adjustment unit 204 performs exposure correction to adjust the average luminance value of the pixels in the detected human body region 522 to an appropriate illuminance value.

FIG. 5D illustrates an image acquired as the result of the first image quality adjustment. The adjustment unit 204 performs exposure correction on the person 521 in FIG. 5C, so that the person 521 is brightened and captured as a person 531 in an image 530.

Herein, the detection unit 202 performs the second human body detection to detect the person 531 in a human body region 532. Thereafter, image quality adjustment may be performed based on the image quality of the human body region 532. Further, when the human body region 532 is detected, the human body region information registered in the exclusion information, which the determination unit 203 has determined that the human body region is located close to the human body region 522, may be deleted. The human body region information may be deleted from the storage area where the exclusion information is registered, or by cancelling an exclusion flag set to that human body region information.

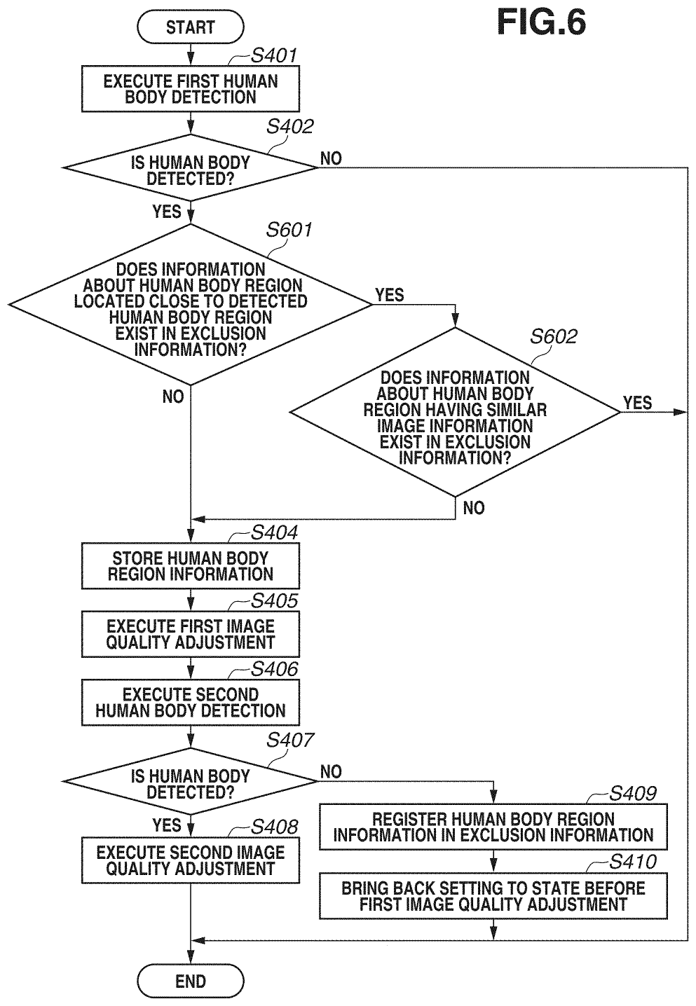

Subsequently, processing for determining similarity between human body regions based on a combination of information about the position of a human body region and image information about the human body regions will be described with reference to a flowchart in FIG. 6. This flowchart illustrates processing performed by the functional blocks of the information processing apparatus 100 illustrated in FIG. 2. Like numbers illustrated in FIG. 4 refer to like processing steps, and the redundant descriptions will be omitted.

First, the processing similar to the processing in FIG. 4 is performed in steps S401 to S402 in FIG. 6, so that the detection unit 202 performs the first human body detection to determine whether a human body region is detected. If a human body region is detected (YES in step S402), the processing proceeds to step S601. Otherwise (NO in step S402), the processing of this flowchart is ended.

Next, in step S601, the determination unit 203 determines whether information about a human body region located close to the human body region detected in step S401 exists in the exclusion information. If information about a human body region located close to the detected human body region exists in the exclusion information (YES in step S601), the processing proceeds to step S602. Otherwise (NO in step S601), the detected human body region is likely to include a person. Thus, the processing proceeds to step S404, and subsequent image quality adjustment processing is performed.

Then, in step S602, the determination unit 203 determines whether human body region information including image information similar to the image information about the human body region detected in step S401 exists in the exclusion information. As described above, the similarity is determined based on the difference between the pixel values of the edge information and the texture information in the human body regions. Further, the movement of an object may be determined through a technique such as moving object detection or moving object tracking, and the determination unit 203 may determine that human body regions are not similar to each other if the object is moved. If the human body region information including similar image information exists in the exclusion information (YES in step S602), that means that the human body region information including similar positional information and similar image information exists in the exclusion information. Thus, the determination unit 203 determines that an object identical to the object the human body region already determined as an object other than a person is detected again, and ends the processing of this flowchart without performing image quality adjustment. If no information about a human body region including similar image information exists in the exclusion information (NO in step S602), that means that the state of the object is changed because a change in image information even though the positions thereof are close to each other. Thus, the processing proceeds to step S404 and subsequent steps, so that the first image quality adjustment and the second human body detection are performed, and a determination is made again on whether a human body region is detected. The processing in step S404 and subsequent steps is similar to the processing illustrated in FIG. 4, and the redundant descriptions thereof will be omitted. In addition, if the determination unit 203 determines that no information about a human body region including similar image information exists in the exclusion information in step S602, that means that the human body region information is updated. Thus, the corresponding human body region information may be deleted from the exclusion information, or an invalidation flag may be set thereto. In other words, if the amount of change in information about a human body region or a face region registered in the exclusion information is a predetermined threshold value or more, the determination unit 203 determines that the state in the human body region is changed, and deletes the corresponding human body region information or sets an invalidation flag thereto.

As described above, according to the present exemplary embodiment, even information about a human body region registered in the exclusion information once is subjected to image quality adjustment again to be determined whether it includes a person in response to a determination by the determination unit 203 that the state of the target object has changed in the image information that has changed. Through the above-described processing, for example, even if a person in a sitting posture or a person facing the other way is determined as an object other than a person and registered in the exclusion information once, a determination is made again at a timing when that person stands up or faces forward.

According to the present exemplary embodiment, image quality adjustment suitable to a person can be performed without missing the person.

A third exemplary embodiment will be described. According to the first exemplary embodiment, the number of pieces of human body region information registered in the exclusion information is increased continuously. Thus, in the present exemplary embodiment, human body region information registered in the exclusion information is invalidated.

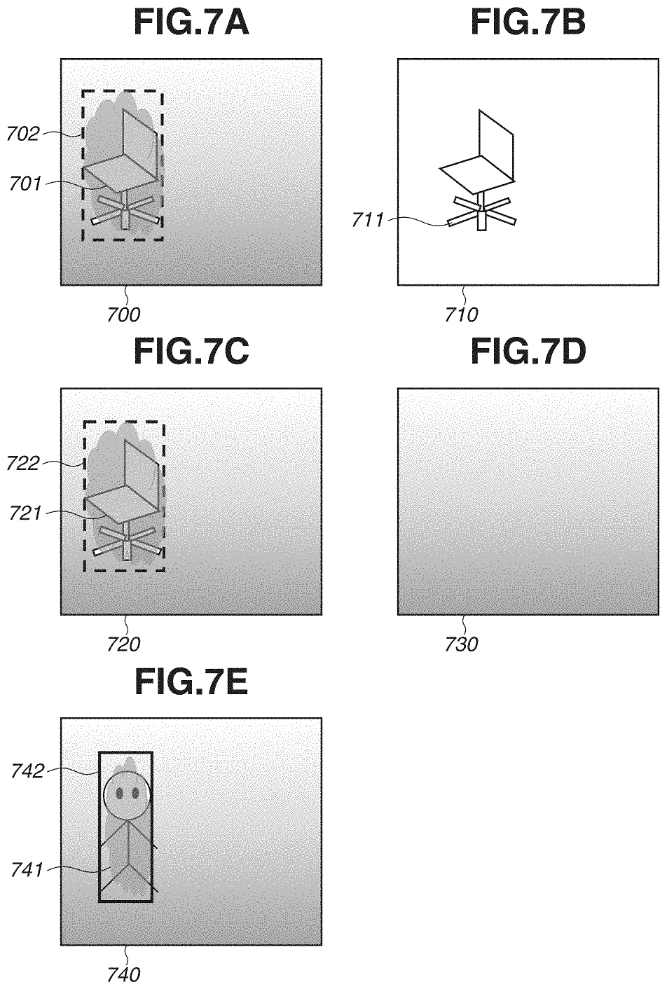

First, information processing performed by the information processing apparatus 100 according to the present exemplary embodiment will be described with reference to FIGS. 7A to 7E.

FIG. 7A illustrates an image 700 acquired by the image capturing apparatus 110 or the recording apparatus 120 via the communication unit 200 at a point of time. A chair 701 is captured in the image 700, and a human body region 702 is detected by the detection unit 202 through the first human body detection. The information about the detected human body region 702 is temporarily stored in the storage unit 201. Herein, the determination unit 203 determines that no information about a human body region similar to the human body region 702 exist in the exclusion information. Thus, the adjustment unit 204 performs the first image quality adjustment based on the image quality of the human body region 702. In the example illustrated in FIGS. 7A to 7E, the adjustment unit 204 performs exposure correction to increase (brighten) the low luminance in the human body region 702. A human body detection method, an image quality adjustment method, and processing for determining the similarity are similar to those described in the first exemplary embodiment, and the redundant descriptions thereof will be omitted.

FIG. 7B illustrates an image acquired as the result of the first image quality adjustment. The adjustment unit 204 performs exposure correction on the chair 701 in FIG. 7A, so that the chair 701 is brightened and captured as a chair 711 in an image 710.

Herein, although the detection unit 202 performs the second human body detection, no human body region is detected because no person exists. Thus, the human body region 702 detected on the image 700 in FIG. 7A is determined as an object other than a person, so that the information about the human body region 702 temporarily stored in the storage unit 201 is registered in the exclusion information. Then, the setting thereof is brought back to a state before the first image quality adjustment.

FIG. 7C illustrates an image in the dark state before the image quality adjustment, which is brought back in the previous processing. The chair 701 exists as a chair 721 in an image 720 in a state almost similar to the state in the image 700 in FIG. 7A, so that the detection unit 202 detects the region including the chair 721 as a human body region 722 again through the first human body detection. Herein, the determination unit 203 determines whether information about a human body region similar to the human body region 722 exists in the exclusion information. In the example illustrated in FIGS. 7A to 7E, the determination unit 203 determines that the human body region 722 is similar to the human body region 702 whose information is registered in the exclusion information. Thus, image quality adjustment is not performed, so that the image 720 remains in a dark state.

In FIG. 7D, the chair 721 existing in the image 720 in FIG. 7C is moved out of the field of view of the camera. In an image 730, the chair 721 does not exist in the screen, so that the detection unit 202 does not detect a human body region. Herein, the information processing apparatus 100 measures the period of time when a human body region similar to the human body region 702 whose information is registered in the exclusion information has not been detected, and invalidates the information about the human body region 702 registered in the exclusion information if a similar human body region is not detected for a predetermined period of time. The information processing apparatus 100 may invalidate the human body region information by deleting the human body region information from the exclusion information, or by setting an invalidation flag thereto. In addition, the human body region information may be deleted from the exclusion information when the detection unit 202 detects that the human body region is moved out of the screen by a technique of moving object detection or moving object tracking.

In FIG. 7E, a person 741 appears at a position where the chair 701 existed. The person 741 exists in an image 740, so that the detection unit 202 detects a human body region 742 through the first human body detection. As the information about the human body region 702 registered in the exclusion information at a time point in FIG. 7A is deleted from the exclusion information, the human body region 742 is regarded as the target of image quality adjustment without being ignored.

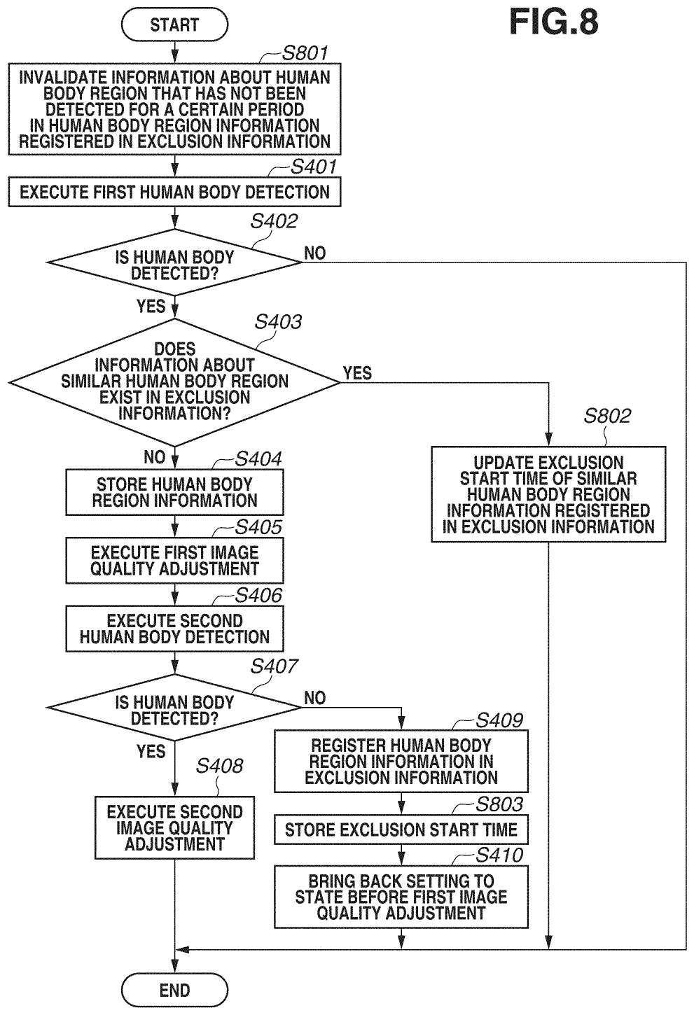

Subsequently, processing for deleting the human body region information from the exclusion information will be described with reference to a flowchart in FIG. 8. This flowchart illustrates processing performed by the functional blocks of the information processing apparatus 100 illustrated in FIG. 2. Like numbers illustrated in FIG. 4 refer to like processing steps, and the redundant descriptions will be omitted.

First, the processing similar to the processing in FIG. 4 is performed in steps S401 to S402 in FIG. 8, so that the detection unit 202 performs the first human body detection to determine whether a human body region is detected.

In step S801, no information about a human body region in which a similar human body region is detected for a predetermined period of time is invalidated from among the human body region information registered in the exclusion information in the storage unit 201. For example, the time can be measured as follows. In the subsequent processing in step S803, a current time when information about a human body region (or face region) is registered in the exclusion information is stored as an updated time in association therewith. Then, the difference between the time when the processing in step S801 is performed and the updated time is measured. Further, in step S801, a determination may be made on whether a human body region moves out of the screen by employing a technique such as moving object detection or moving object tracking, and the information about the corresponding human body region registered in the exclusion information may be invalidated when a human body region is moved out of the screen. As described above, the information processing apparatus 100 may invalidate human body region information by deleting the human body region information from the exclusion information, or by setting an invalidation flag thereto.

The processing in steps S401 to S410 is similar to the processing illustrated in the flowchart in FIG. 4. If no information about a human body region similar to the human body region detected in step S401 exists in the exclusion information (NO in step S403), image quality adjustment is performed based on the image quality of the detected human body region. If information about a human body region similar to the detected human body region exists in the exclusion information (YES in step S403), the processing proceeds to step S802.

In step S802, as information about a human body region similar to the human body region detected in step S401 exists in the exclusion information, an object to be excluded therefrom remains. Thus, the storage unit 201 updates the detection time of the human body region information registered in the exclusion information. Through the above-described processing, the exclusion start time is updated as long as the object to be excluded therefrom remains, so that the human body region information is not deleted in step S801. On the other hand, if no similar human body region is detected, the exclusion start time thereof is not updated, so that the human body region information is deleted in step S801 when a predetermine period of time has passed.

As described above, according to the present exemplary embodiment, even if human body region information is registered in the exclusion information once, that human body region information is invalidated when no similar human body region is detected for a period of time. Alternatively, the corresponding human body region information registered in the exclusion information is invalidated when a human body region is moved out of the screen. Through the above-described configuration, even if a human body region is located close to the human body region whose information is registered in the exclusion information, that human body region can be detected by the human body detection again in response to when conditions are satisfied.

A fourth exemplary embodiment will be described. In the present exemplary embodiment, face detection and human body detection are performed separately. The face detection is performed based on a feature of a face alone. The human body detection is performed on the other portions such as a head, an upper half of the body, and a whole body. In the face detection, a person can be detected more accurately based on a feature of the face. Further, image quality adjustment more suitable to a person can be performed because a region including a face alone is extracted.

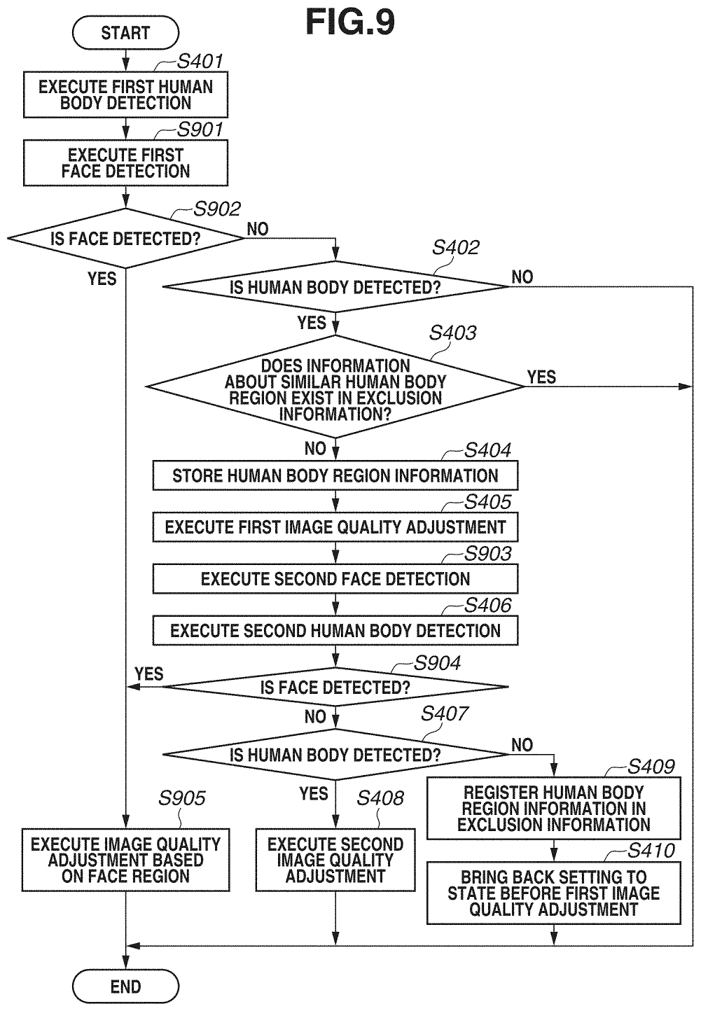

First, processing for performing image quality adjustment employing face detection and human body detection will be described with reference to a flowchart in FIG. 9. This flowchart illustrates processing performed by the functional blocks of the information processing apparatus 100 illustrated in FIG. 2. Like numbers illustrated in FIG. 4 refer to like processing steps, and the redundant descriptions will be omitted.

First, in step S401, the first human body detection is performed. Then, in step S901, the detection unit 202 performs the first face detection. Similar to the human body detection, the face detection can also be performed using a technique such as pattern matching or machine learning. In addition, the face detection may be performed through processing different from processing of human body detection, or may be performed with information about a detected human body region. For example, a face may be detected from a human body region.

In step S902, a determination is made on whether a face is detected in step S901. If a face is detected (YES in step S902), the processing proceeds to step S905. In step S905, image quality adjustment (second image quality adjustment) is performed based on the image quality of the detected face region, and the processing of this flowchart is ended. In addition, the face detection and the image quality adjustment may be performed again after the image quality adjustment is performed in step S905. In this way, the image quality adjustment can be made with an improved accuracy. If no face is detected (NO in step S902), the processing proceeds to step S402 and subsequent steps, so that a determination is made on whether a human body region is detected, and the first image quality adjustment is performed. If a human body region is detected (YES in step S402), and no information about a human body region similar to the detected human body region exists in the exclusion information (NO in step S403), the processing proceeds to step S903.

In step S903, the detection unit 202 performs the second face detection. Up to this point, for example, a human body region is detected although no face is detected because the image is in a dark state. Thus, the image quality adjustment is performed based on the image quality of the detected human body region, so that the image is brightened up as a result. This makes a face more likely to be detected in the face detection in the above-described state again.

In step S904, a determination is made on whether a face is detected in step S903. If a face is detected (YES in step S904), the processing proceeds to step S905. In step S905, the image quality adjustment is performed based on the image quality of the detected face region. Thereafter, the processing of this flowchart is ended. If no face is detected (NO in step S904), the processing proceeds to step S407, so that a determination is made on whether a human body region is detected. Thereafter, the second image quality adjustment or processing for registering human body region information in the exclusion information is performed.

As described above, according to the present exemplary embodiment, the image quality adjustment suitable to the face can be performed with high accuracy through separate highly-accurate face detection and human body detection.

The information processing apparatus 100 according to the present exemplary embodiment includes a CPU 1000, a RAM 1010, a ROM 1020, a HDD 1030, and an I/F 1040.

The CPU 1000 is a central processing unit that collectively controls the information processing apparatus 100. The RAM 1010 temporarily stores computer programs run by the CPU 1000. Further, the RAM 1010 provides a work area used when the CPU 1000 performs processing. The RAM 1010 also functions as a frame memory or a buffer memory.

The ROM 1020 stores a program for causing the CPU 1000 to control the information processing apparatus 100. The HDD 1030 is a storage device that stores image data. The I/F 1040 communicates with an external apparatus via the network 140 through communication protocols such as a transmission control protocol/internet protocol (TCP/IP) and a hypertext transfer protocol (HTTP).

In the above-described exemplary embodiments, the processing is performed by the CPU 1000. However, at least a part of the processing performed by the CPU 1000 may be performed by dedicated hardware. For example, processing for displaying a graphical user interface (GUI) and image data on the display 130 may be performed by a graphics processing unit (GPU). Further, processing for reading out a program code from the ROM 1020 and loading the program code on the RAM 1010 may be performed by a direct memory access (DMA) functioning as a transfer device.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-145182, filed Sep. 7, 2021, which is hereby incorporated by reference herein in its entirety.

What is claimed is:

1. An apparatus comprising:
an acquisition unit configured to acquire an image;
a detection unit configured to detect a first region including a human body on the acquired image;
an adjustment unit configured to perform first image quality adjustment on the acquired image based on an image of the detected first region;
wherein the detection unit further detects the first region or a second region including a face on the adjusted image,
a storage unit configured to store information about the first region as exclusion information in a case where neither the first region nor the second region are detected;
wherein, in a case where the second region is detected, the adjustment unit performs the first image quality adjustment or second image quality adjustment on the adjusted image based on an image of the second region,
a comparison unit configured to compare information about a region detected before the first image quality adjustment and the exclusion information;
wherein the adjustment unit determines whether to perform the first image quality adjustment based on a comparison result obtained by the comparison unit.

2. The apparatus according to claim 1,
wherein the exclusion information includes information about the first region and a current time, and
wherein the storage unit deletes the exclusion information when a predetermined time has passed since the current time.

3. The apparatus according to claim 1, wherein the storage unit stores information about a region in the image specified by a user as the exclusion information.

4. The apparatus according to claim 1,
wherein the comparison unit calculates a difference between information about the region detected before the first image quality adjustment and the exclusion information, and
wherein the adjustment unit determines that the first image quality adjustment is not performed in a case where the difference is a predetermined threshold value or lower.

5. The apparatus according to claim 1, wherein the information about the region detected before the first image quality adjustment and the exclusion information include at least one of information about a position, a size, an edge, or a texture of the first region.

6. The apparatus according to claim 1, wherein the first image quality adjustment and the second image quality adjustment include adjustment relating to exposure.

7. A method for controlling an apparatus, the method comprising:
acquiring an image;
detecting a first region including a human body on the acquired image;
performing first image quality adjustment on the acquired image based on an image of the detected first region;
wherein the first region or a second region including a face is further detected on the adjusted image,
storing information about the first region as exclusion information in a case where neither the first region nor the second region are detected;
wherein, in a case where the second region is detected, the first image quality adjustment or second image quality adjustment is further performed on the adjusted image based on an image of the second region,
comparing information about a region detected before the first image quality adjustment and the exclusion information;
wherein whether to perform the first image quality adjustment is determined based on a result of comparison between the information about a region detected before the first image quality adjustment and the exclusion information.

8. The method according to claim 7,
wherein the exclusion information includes the information about the first region and a current time, and
wherein the exclusion information is deleted when a predetermined time has passed since the current time.

9. The method according to claim 7, wherein information about a region in the image specified by a user is stored as the exclusion information.

10. The method according to claim 7,
wherein the comparison result includes a difference between the information about the region detected before the first image quality adjustment and the exclusion information, and
wherein it is determined that the first image quality adjustment is not to be performed in a case where the difference is less than a predetermined threshold value.

11. The method according to claim 7, wherein the information about the region detected before the first image quality adjustment and the exclusion information include at least one of information about a position, a size, an edge, or a texture of the first region.

12. The method according to claim 7, wherein the first image quality adjustment and the second image quality adjustment include adjustment relating to exposure.

13. A non-transitory computer readable storage medium storing a program that causes a computer to execute a method, the method comprising:
acquiring an image;
detecting a first region including a human body on the acquired image;
performing first image quality adjustment on the acquired image based on an image of the detected first region;
wherein the first region or a second region including a face is further detected on the adjusted image,
storing information about the first region as exclusion information in a case where neither the first region nor the second region are detected;
wherein, in a case where the second region is detected, the first image quality adjustment or second image quality adjustment is further performed on the adjusted image based on an image of the second region,
comparing information about a region detected before the first image quality adjustment and the exclusion information;
wherein whether to perform the first image quality adjustment is determined based on a result of comparison between the information about a region detected before the first image quality adjustment and the exclusion information.

14. The non-transitory computer readable storage medium according to claim 13,
wherein the exclusion information includes the information about the first region and a current time, and
wherein the exclusion information is deleted when a predetermined time has passed since the current time.

15. The non-transitory computer readable storage medium according to claim 13, wherein information about a region in the image specified by a user is stored as the exclusion information.

16. The non-transitory computer readable storage medium according to claim 13,
wherein the comparison result includes a difference between the information about the region detected before the first image quality adjustment and the exclusion information, and
wherein it is determined that the first image quality adjustment is not to be performed in a case where the difference is less than a predetermined threshold value.

17. The non-transitory computer readable storage medium according to claim 13, wherein the information about the region detected before the first image quality adjustment and the exclusion information include at least one of information about a position, a size, an edge, or a texture of the first region.

18. The non-transitory computer readable storage medium according to claim 13, wherein the first image quality adjustment and the second image quality adjustment include adjustment relating to exposure.
